(19) United States
(12) Patent Application Publication
(10) Pub. No.: US 2022/0130059 A1
(43) Pub. Date: Apr. 28, 2022

(54) SYSTEM AND METHOD FOR MEDICAL IMAGE ALIGNMENT

(71) Applicant: Surgical Theater, Inc., Los Angeles, CA (US)

(72) Inventors: MORDECHAI AVISAR, HIGHLAND HEIGHTS, OH (US); Alon Yakob Geri, Orange Village, OH (US); Gidon NAVROTSKY, Binyamina (IL)

(73) Assignee: SURGICAL THEATER, INC., Los Angeles, CA (US)

(21) Appl. No.: 17/510,268

(22) Filed: Oct. 25, 2021

Related U.S. Application Data
(60) Provisional application No. 63/105,082, filed on Oct. 23, 2020.

(51) Int. Cl. G06T 7/30; G06T 7/10

(52) U.S. Cl. CPC G06T 7/30; G06T 7/10; G06T 2207/20101; G06T 2207/30012; G06T 2207/20084; G06T 2207/10081

(57) ABSTRACT

An image alignment system and method which generates X-ray aligned patient specific 3D models. In particular, the image alignment system combines a CT scan and an X-ray into a single patient specific 3D model that, leveraging the benefits of both types of images and providing a surgeon with a single model for diagnosing a spinal deformity, for engaging and education a patient about the spinal deformity, and for preparing for spinal surgery. The system allows the CT scan to be done with the patient in the prone condition while the X-ray can be done with the patient in a vertical, e.g., standing, position to capture impacts on the spine from that vertical position.

### CROSS-REFERENCES TO RELATED APPLICATIONS

This application claims the benefit of U.S. provisional patent application Ser. No. 63/105,082, filed on Oct. 23, 2020, incorporated herein by reference.

### BACKGROUND

Spinal deformity, or abnormal curvature of a spine, can result in pain and discomfort for an individual having such a condition. Once diagnosed, a spinal deformity may be treated using several approaches, one of which is to perform a surgery to correct the deformity. In particular, a spinal deformity surgeon may typically use a combination of different fusion and instrumentation techniques to correct the deformity.

In order diagnose a spinal deformity as well as to plan and prepare for spinal surgery, the surgeon may examine medical images of the patient. For example, a surgeon may examine an x-ray of the patient, which captures images of the bones in the spine. An X-ray, however, does not capture soft tissue such as nerves. Thus, the surgeon may also examine a computed tomography (CT) scan, which is able to capture more detailed images of both bones and soft tissue. However, unlike an X-ray which may be taken of the patient while the patient is standing, a CT scan can only be captured while the patient is lying down. But in order to properly diagnose a spinal deformity, the surgeon may need to examine medical images taken of the patient while the patient is in a standing position, which is when a spinal deformity may appear most clearly. Thus, even though a CT scan offers a benefit over an X-ray by more clearly showing bones and soft tissue, a CT scan may not be as effective for diagnosing a spinal deformity and planning for surgery.

### SUMMARY

Provided are a plurality of example embodiments, including, but not limited to, method for aligning images for providing a patient specific 3D model, comprising the steps of:
an alignment computer receiving an x-ray image of biological features of a particular patient;
the alignment computer receiving CT scan images of the biological features of the particular patient;
the alignment computer converting vertebrae of the CT scan images into segmented polygons;
the alignment computer selecting one or more landmarks on the X-ray image;
the alignment computer aligning the segmented polygons with the x-ray image using the one or more landmarks;
the alignment computer generating the patient specific 3D model utilizing the CT scan images and the X-ray image according to the aligning; and
outputting the patient specific 3D model to a user interface for display to a user.

Also provided is a method for aligning images for providing a patient specific 3D model of the spine of a particular patient, comprising the steps of:
an alignment computer receiving an x-ray image of the spine of the particular patient;
the alignment computer receiving CT scan images of the spine of the particular patient;
the alignment computer converting a plurality of vertebrae of the CT scan images into segmented polygons;
the alignment computer selecting one or more landmarks on the X-ray image;
the alignment computer aligning the segmented polygons with the x-ray image using the one or more landmarks;
the alignment computer generating the patient specific 3D model utilizing the CT scan images and the X-ray image according to the aligning; and
outputting the patient specific 3D model to a user interface for display to a user.

Further provided is a method for aligning images for providing a patient specific 3D model of the spine of a particular patient, comprising the steps of:
an alignment computer receiving an x-ray image of the spine of the particular patient, said x-ray image being taken by an x-ray with the patient provided in a first position;
the alignment computer receiving CT scan images of the spine of the particular patient, said CT Scan being taken with the patient provided in a second position different than said first position;
the alignment computer converting a plurality of vertebrae of the CT scan images into segmented polygons;
the alignment computer selecting one or more landmarks on the X-ray image;
the alignment computer aligning the segmented polygons with the x-ray image using the one or more landmarks;
the alignment computer generating the patient specific 3D model utilizing the CT scan images and the X-ray image according to the aligning; and
outputting the patient specific 3D model to a user interface for display to a user.

Also provided are additional example embodiments, some, but not all of which, are described hereinbelow in more detail.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates an example system for medical image alignment.

FIG. 2 illustrates a method for aligning medical images.

FIG. 3 illustrates a more detailed method for aligning the medical images showing example images.

FIG. 4 illustrates an example computer implementing the example image alignment computer of FIG. 1.

### DETAILED DESCRIPTION

The image alignment system described herein generates X-ray aligned patient specific 3D models. In particular, the image alignment system combines a CT scan and an X-ray into a single patient specific 3D model that, leveraging the benefits of both types of images and providing a surgeon with a single model for diagnosing a spinal deformity, for engaging and education a patient about the spinal deformity, and for preparing for spinal surgery.

It should be appreciated that although specific references to healthcare applications and specifically to a solution for addressing spinal deformity will be made through out the examples described herein, the image alignment system may also be used for other applications where a similar type of procedure for combing multiple image types of a single subject may be useful and applicable.

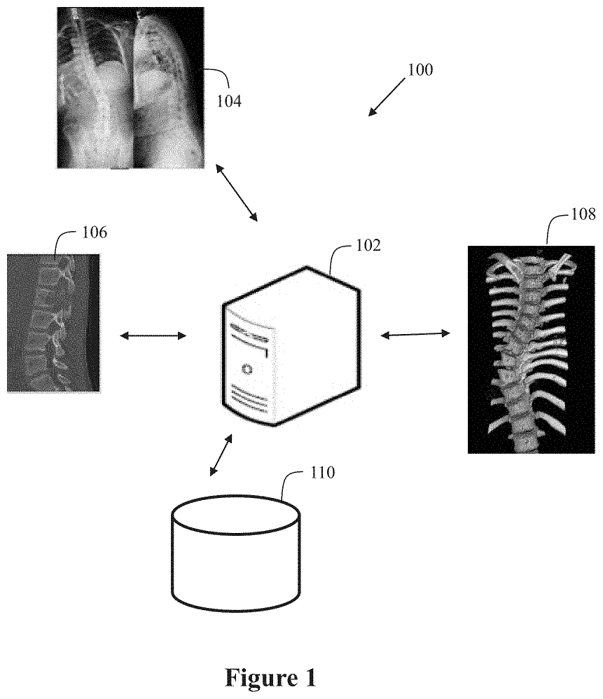

FIG. 1 illustrates an example image alignment system (the “system”) 100. The system 100 includes a medical image alignment computer (“alignment computer”) 102 that receives as input 2 different medical images such as an X-Ray 104 and a CT scan 106 and fuses them together to form a 3D model 108. In particular, each vertebrae of the spine from the CT scan 106 is converted into segmented polygons and aligned with the X-ray 104. Thus, by using the X-ray 104 as a guide, the alignment computer 102 creates a 3D model 108 output which is a representation of the CT scan 106 but in a standing position. In other words, the two images are aligned and fused together.

In order to facilitate the alignment of the two images, the alignment computer 102 uses a landmark as a baseline. The alignment computer 102 includes an AI algorithm that learns from historical data 110 and is able to automatically chose a landmark. In one example, a user may manually select a landmark. Based on the selected landmark, the alignment computer 102 aligns the vertebrate from the CT scan 106 with the X-ray 104. The alignment computer 102 also includes an optimization algorithm for optimizing the alignment and transformation. The generated 3D model 108 can then be used to engage a patient through an augmented reality shared experience with the physician.

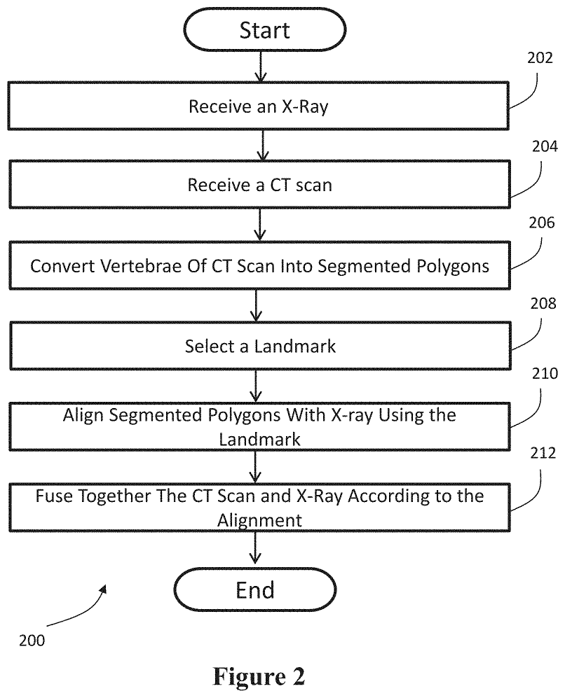

FIG. 2 illustrates an example method for image alignment. At 202, the alignment computer 102 receives an x-ray. At 204, the alignment computer 102 receives a CT scan. At 206, the alignment computer 102 converts the vertebrae of the CT scan into segmented polygons. At 208, the alignment computer 102 selects a landmark on the X-ray. At 210, the alignment computer 102 aligns the segmented polygons with the x-ray using the landmark. At 212, the alignment computer 102 fuses together the CT scan and the X-ray according to the alignment to create a patient specific 3D model and outputs the model to a user interface, such as a computer display or an augmented reality headset.

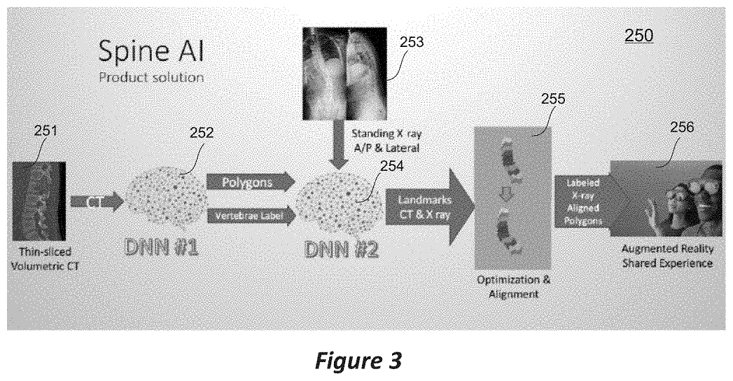

FIG. 3 illustrates a more detailed example method for image alignment 250. A thin-sliced volumetric CT scan 251 of a lying down patient undergoes a first Deep Neural Network (DNN) conversion 252 into segmented, labeled, polygonal model. A x-ray image 253 of the standing patient is then operated on with the segmented polygonal model of the CT scan using a second Deep Neural Network 254 to provide landmarks on the respective model and image. The polygonal CT model and the x-ray landmarks are then optimized and aligned 255, such as by using multiple learning networks for landmark detection, to provide a labeled, color coded, x-ray aligned polygon model that is used to create a patient specific 3D model, which can them be output to a user interface, such as a computer display or an augmented reality headset 256.

These automated, patient specific, 3D models, provide useful details obtained by the combination of the standing x-ray images with the lying down, polygonalize CT scan images, which can then be used by medical professionals to perform spine deformity treatment planning. The end combined result is a “standing” CT scan which provides the benefits of enabling a surgeon to view a patient while standing which is when the deformity is shown best on a scan with the image quality of a CT scan. The resulting models optimize the number of vertebrae with 6 degrees of freedom, and allow shifting between various views of the model image, including AP (front and back), and lateral (side) views. The use of labeling and color coding improves the model effectiveness in planning corrective procedures for the patient.

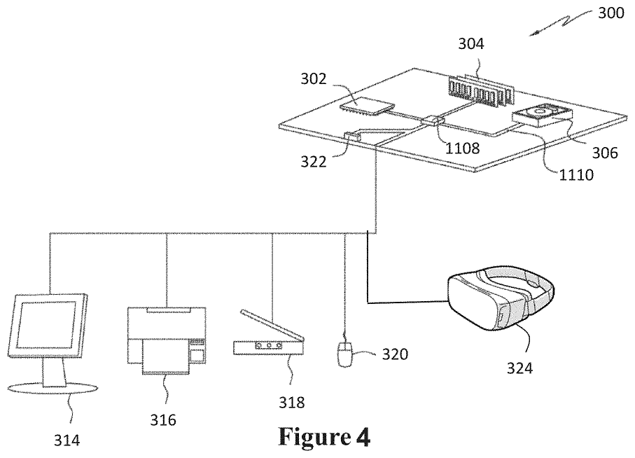

FIG. 4 is a schematic diagram of an example computer for implementing the alignment computer 102 of FIG. 1. The example computer 300 is intended to represent various forms of digital computers, including laptops, desktops, handheld computers, tablet computers, smartphones, servers, AR glasses, and other similar types of computing devices. Computer 300 includes a processor 302, memory 1104, a storage device 306, and a communication port 1108, operably connected by an interface 310 via a bus 312.

Processor 302 processes instructions, via memory 304, for execution within computer 300. In an example embodiment, multiple processors along with multiple memories may be used.

Memory 304 may be volatile memory or non-volatile memory. Memory 304 may be a computer-readable medium, such as a magnetic disk or optical disk. Storage device 306 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 304 or storage device 306.

Computer 300 can be coupled to one or more input and output devices such as a display 314, a printer 316, a scanner 318, a mouse 320, and a HMD 324.

As will be appreciated by one of skill in the art, the example embodiments may be actualized as, or may generally utilize, a method, system, computer program product, or a combination of the foregoing. Accordingly, any of the embodiments may take the form of specialized software comprising executable instructions stored in a storage device for execution on computer hardware, where the software can be stored on a computer-usable storage medium having computer-usable program code embodied in the medium.

Databases may be implemented using commercially available computer applications, such as open source solutions such as MySQL, or closed solutions like Microsoft SQL that may operate on the disclosed servers or on additional computer servers. Databases may utilize relational or object oriented paradigms for storing data, models, and model parameters that are used for the example embodiments disclosed above. Such databases may be customized using known database programming techniques for specialized applicability as disclosed herein.

Any suitable computer usable (computer readable) medium may be utilized for storing the software comprising the executable instructions. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CDROM), or other tangible optical or magnetic storage device; or transmission media such as those supporting the Internet or an intranet.

In the context of this document, a computer usable or computer readable medium may be any medium that can contain, store, communicate, propagate, or transport the program instructions for use by, or in connection with, the instruction execution system, platform, apparatus, or device, which can include any suitable computer (or computer system) including one or more programmable or dedicated processor/controller(s). The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, local communication busses, radio frequency (RF) or other means.

Computer program code having executable instructions for carrying out operations of the example embodiments may be written by conventional means using any computer language, including but not limited to, an interpreted or event driven language such as BASIC, Lisp, VBA, or VBScript, or a GUI embodiment such as visual basic, a compiled programming language such as FORTRAN, COBOL, or Pascal, an object oriented, scripted or unscripted programming language such as Java, JavaScript, Perl, Smalltalk, C++, C#, Object Pascal, or the like, artificial intelligence languages such as Prolog, a real-time embedded language such as Ada, or even more direct or simplified programming using ladder logic, an Assembler language, or directly programming using an appropriate machine language.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

1. A method for aligning images for providing a patient specific 3D model, comprising the steps of:
an alignment computer receiving an x-ray image of biological features of a particular patient;
the alignment computer receiving CT scan images of the biological features of the particular patient;
the alignment computer converting at least a portion of the CT scan images into segmented polygons;
the alignment computer selecting one or more landmarks on the X-ray image;
the alignment computer aligning the segmented polygons with the x-ray image using the one or more landmarks;
the alignment computer generating the patient specific 3D model utilizing the CT scan images and the X-ray image according to the aligning; and
outputting the patient specific 3D model to a user interface for display to a user.

2. The method of claim 1, wherein the CT scan images are obtained from a CT scan of the patient that is performed with the patient in a prone or horizontal position.

3. The method of claim 2, wherein said x-ray scan images are obtained from a x-ray of the patient that is performed with the patient in a standing or vertical position.

4. The method of claim 1, wherein said x-ray scan images are obtained from a x-ray of the patient that is performed with the patient in a standing or vertical position.

5. The method of claim 1, wherein said biological features of the patient include at least a portion of the spine of the patient.

6. The method of claim 1, wherein the alignment computer converts at least a portion of the CT scan images into segmented polygons using a deep neural network.

7. A method of treating the patient using a plurality of views provided by the patient specific 3D model generated by claim 1.

8. The method of claim 1, wherein the alignment computer detects said one or more landmarks using multiple learning networks.

9. The method of claim 1, wherein the alignment computer is configured to generate said 3D model to have 6 degrees of freedom.

10. A method for aligning images for providing a patient specific 3D model of the spine of a particular patient, comprising the steps of:
an alignment computer receiving an x-ray image of the spine of the particular patient;
the alignment computer receiving CT scan images of the spine of the particular patient;
the alignment computer converting a plurality of vertebrae of the CT scan images into segmented polygons;
the alignment computer selecting one or more landmarks on the X-ray image;
the alignment computer aligning the segmented polygons with the x-ray image using the one or more landmarks;
the alignment computer generating the patient specific 3D model utilizing the CT scan images and the X-ray image according to the aligning; and
outputting the patient specific 3D model to a user interface for display to a user.

11. The method of claim 10, wherein the CT scan images are obtained from a CT scan of the patient that is performed with the patient in a prone or horizontal position.

12. The method of claim 11, wherein said x-ray scan images are obtained from a x-ray of the patient that is performed with the patient in a standing or vertical position.

13. The method of claim 10, wherein said x-ray scan images are obtained from a x-ray of the patient that is performed with the patient in a standing or vertical position.

14. The method of claim 10, wherein the alignment computer converts at least a portion of the CT scan images into segmented polygons using a deep neural network.

15. A method of treating the patient using a plurality of views provided by the patient specific 3D model generated by claim 1.

16. The method of claim 10, wherein the alignment computer detects said one or more landmarks using multiple learning networks.

17. The method of claim 10, wherein the alignment computer is configured to generate said 3D model to have 6 degrees of freedom.

18. A method for aligning images for providing a patient specific 3D model of the spine of a particular patient, comprising the steps of:
an alignment computer receiving an x-ray image of the spine of the particular patient, said x-ray image being taken by an x-ray with the patient provided in a first position;
the alignment computer receiving CT scan images of the spine of the particular patient, said CT Scan being taken with the patient provided in a second position different than said first position;
the alignment computer converting a plurality of vertebrae of the CT scan images into segmented polygons;
the alignment computer selecting one or more landmarks on the X-ray image;
the alignment computer aligning the segmented polygons with the x-ray image using the one or more landmarks;
the alignment computer generating the patient specific 3D model utilizing the CT scan images and the X-ray image according to the aligning; and
outputting the patient specific 3D model to a user interface for display to a user.

19. The method of claim 18, wherein the alignment computer is configured to generate said 3D model to have 6 degrees of freedom.

20. A method for aiding a spine deformation treatment for a particular patient using a patient specific 3D model of the spine of the particular patient, comprising the steps of:
an alignment computer receiving an x-ray image of the spine of the particular patient, said x-ray image being taken by an x-ray with the patient provided in a first position;
the alignment computer receiving CT scan images of the spine of the particular patient, said CT Scan being taken with the patient provided in a second position different than said first position;
the alignment computer converting a plurality of vertebrae of the CT scan images into segmented polygons;
the alignment computer selecting one or more landmarks on the X-ray image;
the alignment computer aligning the segmented polygons with the x-ray image using the one or more landmarks;
the alignment computer generating the patient specific 3D model utilizing the CT scan images and the X-ray image according to the aligning;
outputting the patient specific 3D model to a user interface for displaying a plurality of different views of the spine of the particular patient to a user.
